(19) United States
(12) Patent Application Publication
(10) Pub. No.: US 2012/0084248 A1
(43) Pub. Date: Apr. 5, 2012

(54) PROVIDING SUGGESTIONS BASED ON USER INTENT

(75) Inventor: Alexandru Gavrilescu, Redmond, WA (US)

(73) Assignee: Microsoft Corporation, Redmond, WA (US)

(21) Appl. No.: 12/894,243

(22) Filed: Sep. 30, 2010

(51) Int. Cl. G06N 5/02

(52) U.S. Cl. 706/52; 706/54

(57) ABSTRACT

One or more techniques and/or systems are disclosed herein for providing prioritized suggestions to a user of a mobile device, for example, in real-time based on an intent of the user. A user routine is identified by identifying a plurality of historical user patterns, such as for travel, data consumption, communications, etc. A real-time context for the user, such as what the user is currently engaged in or what's going on around them, is identified using real-time contextual data from one or more sensors. The intent of the user is determined by comparing the user routine with the real-time context for the user, and suggestions are prioritized for the user, based on the intent, such as in a mobile device display.

### BACKGROUND

In a computing environment, predicting a user's behavior can add utility to businesses and provide a benefit to the users. For example, when an online user enters a query, comprising search terms, into an online search engine the search engine will often attempt to predict what the user is searching for (e.g., based on the terms and other information) and provide relevant search results for the user, along with relevant advertisements, promotions, and/or coupons for businesses. Further, user behavior predictions can be used to plan resource allocation (e.g., servers and systems to accommodate traffic) and/or information provisions to the user (e.g., providing traffic information or upcoming attractions/businesses on a GPS system based on a planned route).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Attempting to predict a user's behavior can often be problematic, as humans can be particularly unpredictable. Further, when utilizing predictions to provide relevant results (e.g., information, data, suggested activities, tasks, etc.) there is a likelihood that results that are not relevant may not be well received, particularly when the results are suggested to the user without the user's prompting for them (e.g., receiving promotions, ads, or even suggested activities and tasks on the user's mobile phone). Current and prior systems and techniques are deficient because they attempt to anticipate what a user is going to do next, or what their intended achievements may be. These systems and techniques often fail to provide the user with relevant information or suggestions, because human behavior is often unpredictable, and may end up frustrating the user with an inundation of irrelevant information.

Accordingly, one or more techniques and/or systems are disclosed that identify regular patterns of users, and utilize the user's regular patterns to identify intent in order to prioritize information presented to the user (e.g., on a mobile device). While human behavior is often unpredictable at any particular moment, human patterns can be developed for certain activities (e.g., traveling, phone use, data use) that have a high degree of predictability. For example, on an hourly basis, the real uncertainty of a person's whereabouts is less than two locations. These highly predictable patterns can be used to identify intent and prioritize suggestions for the user.

In one embodiment for providing prioritized suggestions to a user of a mobile device in real-time based on an intent of the user, a routine of the user is identified by identifying a plurality of historical user patterns. Further, a real-time context for the user is identified using real-time contextual data from one or more sensors. The intent of the user is determined by comparing the routine with the real-time context. Additionally, suggestions for the user (e.g., suggested activities, tasks, and information) are prioritized based on the intent.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram of an exemplary method for providing prioritized suggestions to a user of a mobile device in real-time based on an intent of the user.

FIG. 2 is a flow diagram illustrating an example embodiment where one or more techniques described herein may be implemented.

FIG. 3 is an illustration of an example embodiment, where one or more techniques and/or systems described herein may be implemented.

FIG. 4 is a component diagram of an example system for providing prioritized suggestions to a user of a mobile device in real-time based on an intent of the user.

FIG. 5 is a component diagram illustrating an example embodiment where one or more systems described herein may be implemented.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

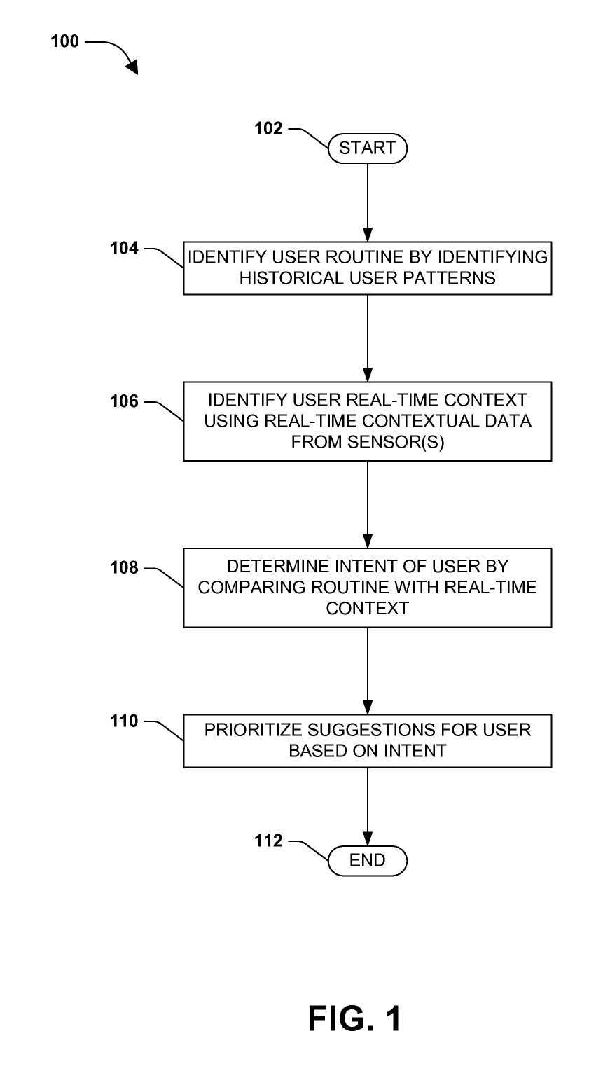

A method may be devised that utilizes a predicted intent of a user to present prioritized suggestions to the user, based on a user routine and real-time information about the user. FIG. 1 is a flow diagram of an exemplary method 100 for providing prioritized suggestions to a user of a mobile device in real-time based on an intent of the user. The exemplary method 100 begins at 102 and involves identifying a routine of the user by identifying a plurality of historical user patterns, at 104.

In one embodiment, user patterns can comprise information related to historical contextual data for the user, for example, that identifies what the user has been engaged in previously. In one embodiment, a user's historical travel pattern may be identified by tracking and logging the user's locations in relation to time (e.g., map coordinates at a particular time), such as by using a mobile device's (e.g., smart phone) global positioning systems (GPS) function. In this way, in this example, the user's driving routes, commuting routes, and other travel activity can be identified as a travel pattern (e.g., train to work and back Monday through Friday, drive to soccer field after work Tuesday and Thursday, drive to Mother's house, church then back to mother's house and home every Sunday).

In another example, identifying a user historical pattern can comprise identifying the user's data consumption pattern. A data consumption pattern can comprise what types and amounts of data the user accesses, downloads, and uploads, for example, in relation to time (e.g., time of day and length of time). In one embodiment, the data consumption pattern can comprise data involving the user's mobile device. That is, for example, when the user accesses the Internet, performs searches, browses to websites, and downloads and uploads data to/from their mobile device, the data can be anonymously tracked and logged. Further, the times of day and length of time using/accessing the data, for example, can be tracked and logged. In this way, in this example, a pattern of data consumption may be identified by how the user has historically accessed/used data from their mobile device.

As an illustrative example, every weekday morning the user may walk to the train station to catch a commuter train to work. On the way, they stop at the local coffee shop, and then board the train at the station. While waiting for the train and riding the train, the user uses their mobile device to check sports scores from last night games, reads some morning news, checks their email and updates their social network status. Before lunch, the user uses their mobile device to check their social network, looks for local lunch specials online, then walks to a local café for lunch, where they catch up on more emails and the stock market. After work, the user walks to the train station to catch the train home, and makes reservations for dinner and a movie on their mobile device. In this example, the user's historical weekday travel patterns can be tracked by GPA and logged with the times and durations for the various locations; and the data consumption patterns, along with times of day and durations, can be anonymously tracked and logged.

At 106 in the exemplary method 100, a real-time context for the user can be identified using real-time contextual data that is gathered from one or more sensors. Mobile devices typically comprise a plurality of sensors that can generate contextual data for a user of the device. For example, most smart phones comprise a GPS tracker, a clock, components for tracking data use and communications (e.g., phone calls); some comprise an accelerometer, position sensor, and other sensors. Further, sensors can comprise any component, application, and/or system that gathers, tracks and/or logs relevant contextual information for the user, such as a feed that provides current weather conditions at the user's location and/or one or more health monitors that monitor one or more user conditions (e.g., heart rate monitor, blood pressure monitor, etc.), etc. In one embodiment, sensors may be associated with and/or located in a variety of components associated with the user. For example, sensors can be located in the user's shoes (e.g., running shoes to monitor pace, number of steps taken, etc.), clothing and/or other equipments used and/or otherwise associated with the user. As another example, there may be one or more sensors located in the user's transportation (e.g., car, bike, etc.), and the transportation can be associated with the user allow for user patterns and/or data or information to be obtained and/or developed.

Contextual data can comprise any data that informs of real-time information about the user. That is, for example, the real-time contextual data is relevant to what the user is doing and/or experiencing at the time of the data generation. For example, the current location of the user, as indicated by the GPS on their smart phone, may show that they are at the train station, which may in turn have an associated weather condition status, the clock in their phone indicates current time of 8 AM and the day of the week is Tuesday, and the user's data component indicates the user is currently viewing sports scores on their smart phone. In this example, the contextual data can be combined into a real-time context for the user.

At 108 in the exemplary method 100, the intent of the user is determined by comparing the routine with the real-time context. In one embodiment, the contextual data of the real-time context can be matched against the historical user patterns of the routine. For example, the location of the train station, along with the time and day, may match the morning commute travel pattern. Further, the user viewing sports scores can also indicate the morning commute data consumption pattern. Therefore, in this example, the user intent may be indicated that the user is commuting to work, is preparing to board the train to commute to work. Further, that the user may next wish to view current news, read emails and update their social network status, for example.

At 110, suggestions for the user are prioritized based on the determined intent. Suggestions can comprise information, applications, activities, and other data that can be viewed or interacted with by the user on a computing device, such as a mobile device. For example, by learning the user's routine from the patterns the user's intent can be predicted and the user's potential needs can be anticipated. In this way, in this example, appropriate tasks, actions and information can be provided in a prioritized way, when the user actually may need it (if not before).

As an illustrative example, the routine can help identify when the user goes shopping for groceries. In this example, when the context indentifies that the user is following this normal routine, suggestions for coupon offerings from several grocery stores can be provided and prioritized (e.g., by location to the user) ahead of time. In this way, the user can plan where to shop ahead of time, instead of receiving coupons while in the store.

As another illustrative example, the routine can help identify when the user typically wakes up on a work day. In this example, a suggestions summary of emails and social network traffic may be provided, based on the user's data consumption patterns, prioritized by people having a closer relationship to the user. A summary of news and events can be provided to the user, prioritized based on the user's data consumption patterns, and matched with the contextual data. For example, if traffic is particularly heavy or the weather is inclement (e.g., leading to a longer commute time) this news can be prioritized, along with sports scores and other information deemed appropriate based on the intent and context. Similarly, the user's device can sound an alarm to wake the user earlier if it is a work day and an longer commute time is anticipated, for example.

Having prioritized suggestions for the user, the exemplary method 100 ends at 112.

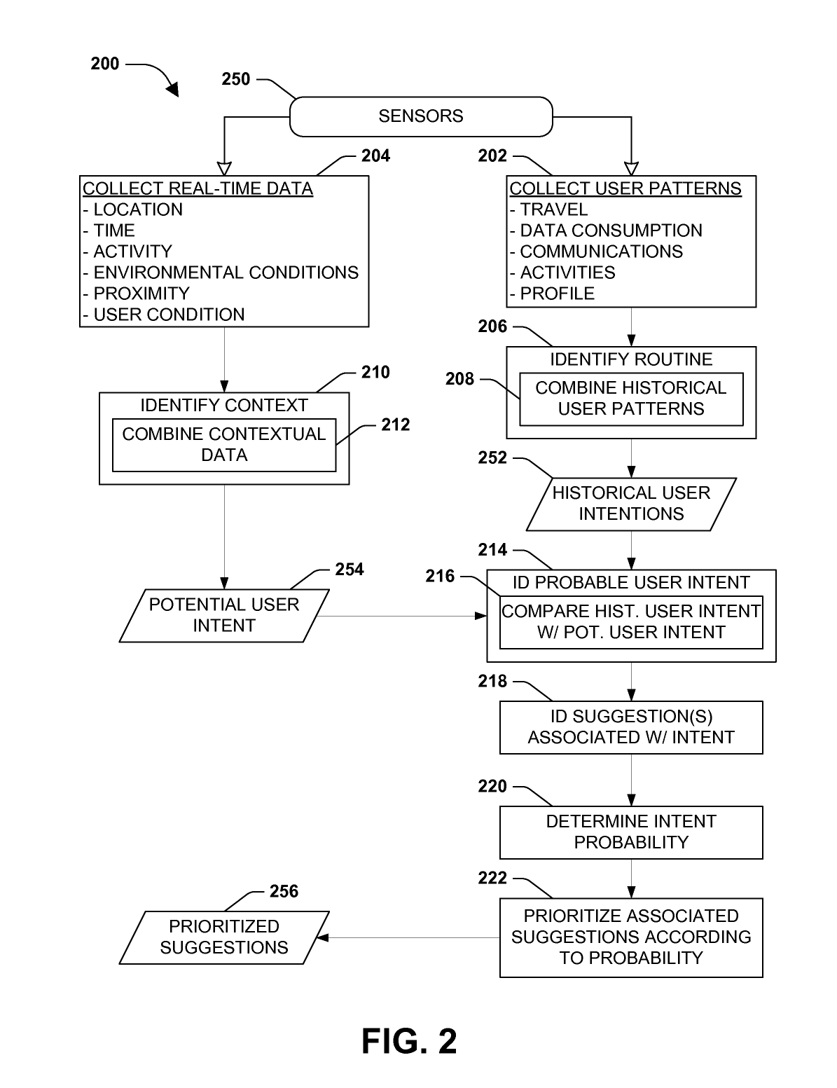

FIG. 2 is a flow diagram illustrating an example embodiment 200 where one or more techniques described herein may be implemented. At 202, sensors 250 can provide information used to collect user patterns. In one embodiment, the user patterns can comprise a user travel pattern. As described above, the user travel patterns can comprise the locations the user travels and the times (e.g., when and how long) the user is present at the locations. In one embodiment, the locations and times can be organized in a manner that distinguishes a particular travel pattern, such as morning commute, evening commute, trip to store, friends, parents, regular event or even just staying at home, school or work, for example.

In one embodiment, the user pattern can comprise a user data consumption pattern. As described above, the user data consumption pattern can comprise data viewed, accessed, downloaded and/or uploaded by the user, such as on their mobile device. In this embodiment, the user's website visits, searching, social networking, etc., can be monitored in relation to the time of day and location to develop a pattern about how the user consumes data, by time of day, location, and/or source. Further, the user data consumption pattern can comprise the times (e.g., when, how long, how often) the user access/views the data. The types of data and associated times can be organized in a manner that distinguishes particular data consumptions patterns, for example, waking up, commute, at work, lunch-time, evenings, weekends, etc.

In one embodiment, the user pattern can comprise a user communications pattern. For example, the user may make and receive phone calls, send and receive emails and text, and/or engage in online chat using their mobile device. In this embodiment, phone usage, messaging, and social network usage, for example, in relation with a time and location, can develop a pattern about who the user communication with, and how they communicate. Information associated with the types of communications, along with associated times, durations, and/or regularity of the communications can be collected anonymously. In one embodiment, the communication types and times can be organized in a manner that facilitates distinguishing particular communications patterns, for example, similar to the data consumption patterns described above.

In one embodiment, the user pattern can comprise a user activities pattern. The user activities pattern may comprise activities that are identified by monitoring the user's calendars, phone call activity, multimedia usage, and/or credit card activity, for example, to develop a pattern of activities the user engages in, associated with time of day and/or location. For example, the user may listen to music, download music or files, go to meetings, shop online or at a store, interact with people online or by communicating, or shut off their communications device (e.g., do not disturb, such as when sleeping). In one embodiment, the user activity types and times can be organized in a manner that facilitates distinguishing particular activities patterns. Further, the user may input information about particular activities (e.g., while traveling or at a location), and the time and/or location can be collected from the sensors 250, for example.

In one embodiment, credit card and/or other payment related activity can be correlated with a user (e.g., relative to shopping). As an illustrative example, the user may engage in retail establishment type of shopping activities using a phone to make payments. For example, the user may be setup to make payments using their mobile phone, such as by making use of a payment application running on the phone that uses a particular RF signal component to match chip embedded credit cards, for example, similarly, the phone can be associated with a particular account and an application on the phone allows money to be extracted from that account to pay at retail locations. In another embodiment, one or more online services may be enabled (e.g., by the user) to data mine credit and/or debit statements, for example, of one or more user designated accounts to ascertain information about shopping patterns, for example. It will be appreciated that online shopping patterns can be tracked as well, in addition to retail shopping patterns.

In one embodiment, the user pattern can comprise user profile information. For example, the user may register with an online service, such as a front page online launch platform, social networking service, or some other website that collects user information. In one embodiment, the information from the user profile can be collected, such as age, gender, and other potentially relevant information, in order to develop a user profile pattern. Further, email account information may be collected to identify the work place or school, for example, that the user sends/receives email from. This information can be intersected with a travel pattern and/or local directories to potentially identify the user profile pattern information, for example, such as where their home, work, school is located.

At 206 in the example embodiment 200, a user routine is identified. In one embodiment, identifying the user routine comprises combining at least some of the plurality of historical user patterns, at 208, in order to identify one or more historical user intentions 252. In one embodiment, information can be collected from the sensors 250 over a desired period of time to provide for the one or more historical user patterns. These patterns can be combined, from the desired period of time, to derive a user routine. For example, an accelerometer, GPS and clock in a mobile device can be used to identify travel patterns, which can be combined with activities patterns derived from monitoring the user's calendars, phone calls, multimedia usage and credit card activity over the past month (e.g., desired time period) to identify a routine for when and where the user shops during the summer (e.g., an historical user intention 252), for example.

At 204, real-time data can be collected from one or more sensors 250. Real-time data can comprise contextual data for the user at a desired time (e.g., when the data is requested). For example, the real-time contextual data can help identify what is happening in relation to the user at any particular moment in time. Sensors 250 can indicate, among other things, a current location of the user (e.g., GPS), a current time (e.g., clock), a current activity for the user (e.g., accelerometer, phone monitor, light sensor, pedometer), environmental conditions for the user (e.g., thermometer, weather sensors, weather data from online sites), a proximity of the user to a desired location (e.g., GPS, mapping data, ranging monitors), and/or a user condition (e.g., health monitors).

At 210, a real-time context is identified for the user, which can comprise utilizing real-time contextual data, such as received from the sensors 250. In one embodiment, the real-time contextual data can indicate, as described above, a location of the user, a current time for the location of the user, an activity for the user, one or more environmental conditions for the location of the user, a proximity of the user to a desired location, and/or a condition of the user.

At 212, the real-time contextual data can be combined to identify a potential user intention 254. A potential user intention can comprise one or more contextual data that provides an indication of what the user is currently doing, for example. As an illustrative example, the clock may indicate that it is 5:30 PM on Thursday, and the user's location, activity, and proximity may indicate that they are traveling along a commuter train route towards their home. In this example, the potential user intention 254 can comprise the combination of this information (e.g., location, time, activity, proximity).

At 214, a probable user intent can be identified, for example, by comparing the routine with the context for the user. At 216, comparing the routine with the real-time context can comprise comparing one or more historical user intentions 252 with one or more potential user intentions 254 to identify the probable user intent. Further, in one embodiment, the intent of the user can be determined by combining one or more historical user patterns with real-time contextual data to identify a user intent.

As an illustrative example, elements of the potential user intent 254 (e.g., location, time, activity, proximity, environmental conditions, and/or user condition) can be compared to one or more historical user intentions 252 in order to identify a closest match. For example, the potential user intent that comprises a current time of 5:30 PM on Thursday, and a location, activity, and proximity that indicates the user is traveling along a commuter train route towards their home, may provide a closest match to a historical user intention indicating the user is commuting from work to home (e.g., based on one or more historical user patterns). In one embodiment, more than one probable user intent may be identified by the comparison (e.g., at 216).

At 218 of the example embodiment 200, suggestions associated with the intent can be identified using the user routine and the real-time context. Suggestions can comprise suggested tasks, activities, information, content, or even reminders. As an illustrative example, the user routine can facilitate identifying suggestions based on what the user has done in the past (e.g., content viewed, places gone, items purchased, activities performed). In this example, where the user typically views news, social networks messages and emails during their commute to work, and/or makes calls, plans evening events and checks stocks on their way home from work, this information can be used to identify the suggestions (e.g., suggest viewing news, making calls, etc.).

In one embodiment, identifying suggestions can comprise identifying a task previously performed by the user (e.g., making a call); an activity previously performed by the user (e.g., going to the grocery store); a type of data previously viewed by the user (e.g., sports scores); a type of data previously interacted with by the user (e.g., online application, such as a game); a suggestion identified as an area of interest by the user (e.g., in the user profile, such as soccer practice). In this embodiment, suggestions can be identified from any one or more of these patterns, based on the contextual information, for example, news items in the morning, etc.

At 220 in the example embodiment 200, a probability for the user intent can be determined. In one embodiment, determining the probability for the intent can comprises determining a likelihood of matching the intent to a preferred intent for the user. For example, a plurality of potential user intents can be matched against a database comprising historical user intentions, and respective potential user intents can be associated with a probability based on matching criteria (e.g., using a probability algorithm that matches elements from the potential intent to the historical intention database).

In this example, those potential user intent that match more elements can be assigned a higher probability. For example, every Saturday morning the user tends to drive to the local park for soccer practice during the spring and early summer, and the contextual data shows that the user is currently leaving their house at about the same time they normally would for soccer practice. However, this day, the contextual data shows that the user location is currently experiencing heavy thunderstorms. Typically, when the weather is in this condition the user goes to the local coffee shop and gets online to socialize, etc. Therefore, both the soccer practice intent and coffee shop intent may have high probabilities, but the coffee shop may have a higher probability based on matching criteria to the historical patterns.

At 222, the suggestions associated with the intent are prioritized according to the respective probabilities of the intents. In one embodiment, prioritizing the suggestions can comprise prioritizing suggested user tasks, suggested user activities, suggested data for the user to view, and/or suggested data with which the user can interact. The prioritized suggestions 256 can then be made available to the user, such as by being displayed on a screen of their mobile device (e.g., smart phone).

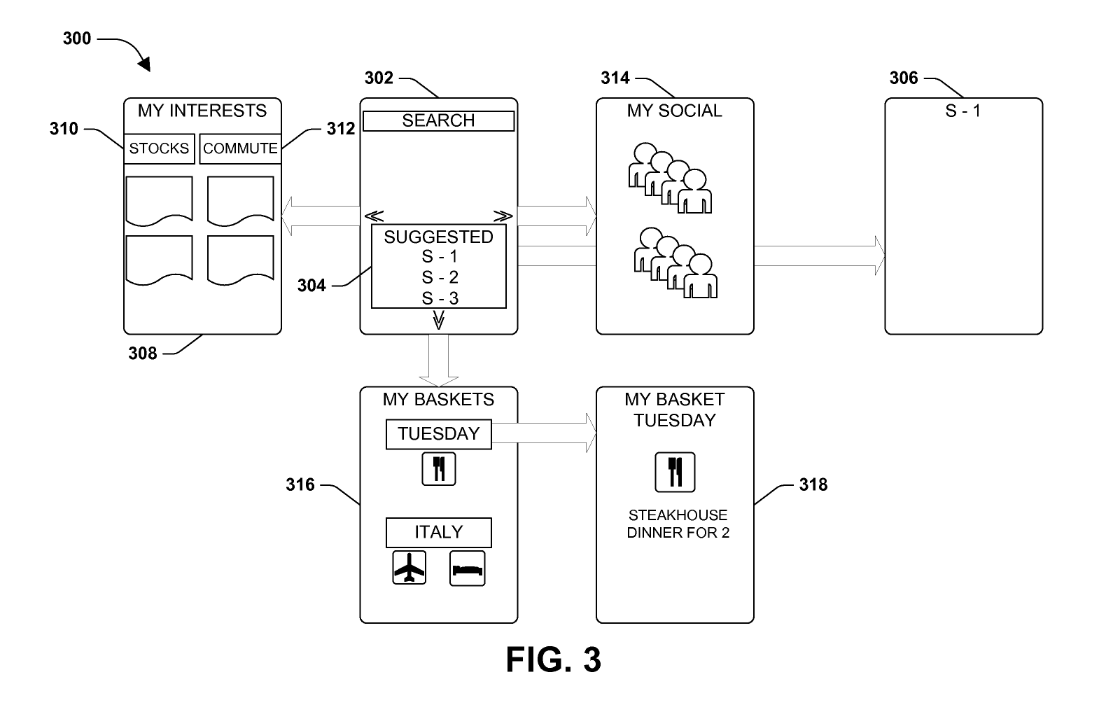

For example, as illustrated in the FIG. 3, a start page 302 for the user's device can comprise a list of prioritized suggestions 304. The prioritized suggestions 304 may comprise suggested news summaries, relevant social network updates, movie times for the local cinema, traffic updates, or other suggestions prioritized based on the user intent. In one embodiment, the user may select one of the suggestions, S-1, and the user may be directed to a page for the suggestion 306. As an example, the page (e.g., 306) may open a new summary of emails that have been prioritized based on the user intent (e.g., relevant senders, important subjects relative to the time and location of the user).

In one embodiment, the routine can be updated using information from the real-time context in order to identify an updated user pattern. The user intent may not be a fixed determination, for example, it can be changing over time. In one embodiment, contextual information can be collected by sensors (e.g., 250 of FIG. 2) and used to update the historical user patterns, and/or the potential user intents. In this embodiment, the updated user patterns can be used to update the user historical intentions. These updated historical intentions can be compared with updated potential intentions from updated context, to provide updated intent for the user, for example.

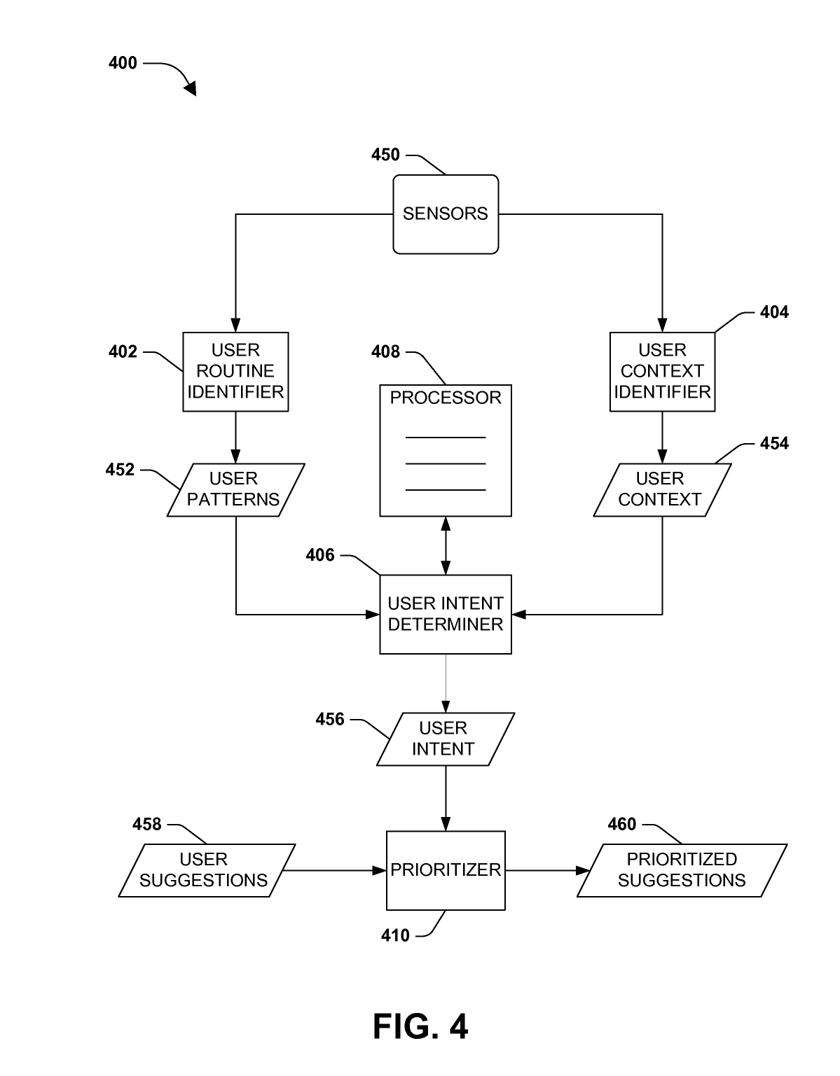

A system may be devised that utilizes a user intent to identify and present prioritized suggestions to the user, based on a user routine and real-time information about the user. FIG. 4 is a component diagram of an example system 400 for providing prioritized suggestions to a user of a mobile device in real-time based on an intent of the user. A processor 408 processes data for the system 400. A user routine identification component 402 identifies a plurality of user patterns 452 that are associated with contextual data, such as provided by sensors 450.

A user context identification component 404 uses real-time contextual data from a plurality of sensors 450 to identify a context 454 for the user. A user intent determination component 406 uses the processor 408 to combine the user patterns 452 with the context 454 to identify a user intent 456 in real-time. A prioritization component 410 prioritizes user suggestions 458 based on the intent 456, thereby providing prioritized suggestions, such as for presentation on the user's mobile device, for example.

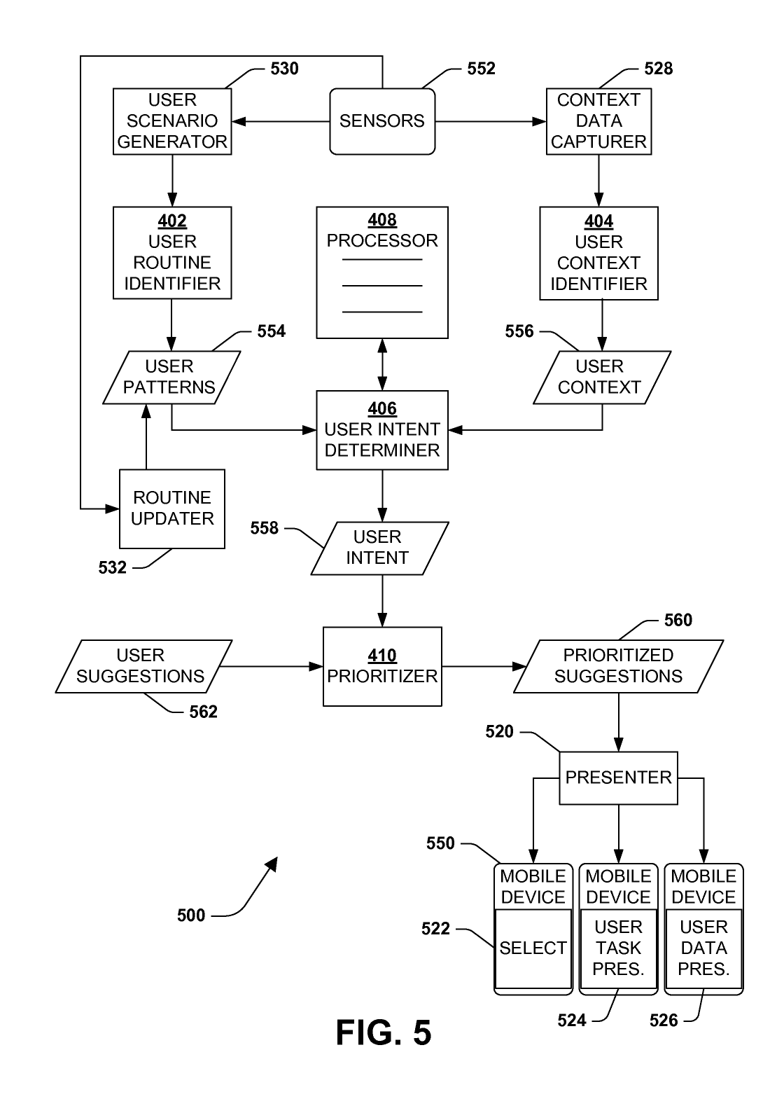

FIG. 5 is a component diagram illustrating an example embodiment 500 where one or more systems described herein may be implemented. A presentation component 520 can present the prioritized user suggestions 560 to the user on the mobile device 550. In one embodiment, the presentation component 520 comprises a user task presentation component 524 that presents prioritized tasks to the user, based on the intent 558. For example, as illustrated in FIG. 3, the user may move from the start screen 302 to a task presentation screen 316. In this example, task suggestions can be prioritized based on a plurality of user patterns and contextual data.

For example, the current day may be Tuesday, and the user has a suggested task 318 presented that comprises dinner for two at the Steakhouse. In one embodiment, the user may select the task to make reservations online, for example. As another example, the user's calendar may have indicated an upcoming trip to Italy, along with data consumption patterns (e.g., searching online about Italy) and communication patterns (calls and/or emails to Italy), the suggested task may include making flight reservations and accommodations, for example.

In one embodiment, the presentation component 520 can comprise a user data presentation component 526 that presents prioritized data for the user to use, based on the intent. For example, as illustrated in FIG. 3, the user may move from the start screen 302 to a data presentation screen 308. In this example, the data presentation screen 308 can comprise information of interest to the user at the time of navigation to the screen, based on the user intent 558. For example, the user may typically review the previous days stock market 310, which can be prioritized based on the user's prior data consumption patterns regarding stocks; and the user may typically view news related to their commute 312, such as local traffic, local news, etc, which can also be prioritized based on the user historical pattern(s).

In one embodiment, the presentation component 520 can comprise a selection component 522 that can allow the user to select a suggestion for further use by the user. For example, as described above and illustrated in FIG. 3, the start screen 302 can comprise prioritized suggestions 304 for the user, which the user can select and interact with 306, such as navigating to a website, email account, social networking 314, or other suggested tasks, activities, data, etc.

The example embodiment 500 of the system comprises a contextual data capture component 528 that can receive contextual data from the plurality of sensors 552. The contextual data capture component 528 can provide the contextual data to the user context identification component 404, for use in determining user context 556, for example. In one embodiment, the sensors 552 can comprise: a global positioning service (GPS) sensor; a location sensing component (e.g., RFID); an accelerometer; a clock; an online user agent component (e.g., browser); an email component; a telephonic component; a user profile database component; a mapping component; one or more environmental sensing components (e.g., weather stations, online weather data); and/or a user-based personal sensing component (e.g., detecting a presence of the user online, input by the user regarding contextual information, a heart rate monitor, etc.). It will be appreciated that the sensors are not limited to these embodiments or example, and it is anticipated that those skilled in the art may devise alternate sensors that can be used to collect contextual information about the user.

A user scenario generation component 530 can generate daily routine scenarios for the user for use by the user routine identification component 402. In one embodiment, the user scenario generation component 530 can utilize collected information from the sensors to identify and/or generate scenarios. As an example, these scenarios can be used to help identify user intent 558, user suggestions 562, and prioritize the suggestions 560 based on probability, for example. Generated scenarios can comprise a morning scenario that comprises a time from when the user rises to when the user leaves home, for example, from a time just before the user gets out of bed until they leave for work (e.g., which may not occur in the morning for those on third shift).

Generated scenarios can comprise a commute scenario, comprising a time when the user is traveling, such as in the car or on a commuter transport to or from work or school; and a daytime scenario that comprises a time during which the user engages in a work or school routine (e.g., or any other daytime related activity, such as if the user does not traditionally travel to a work or school place). Further, generated scenarios can comprise a lunchtime scenario that comprises a time during which the user engages in lunchtime activities (e.g., and/or break time activities); and an evening scenario that comprises a time from when the user arrives home until the user goes to sleep. Additionally, generated scenarios can comprise a weekend scenario comprising a time when the user is not engaged in work or school for one or more days (e.g., at the end of the week, or during the week if the user works on weekends, or even during a vacation period).

A user routine updating component 532 updates one or more patterns 554 for the user using contextual information, such as from the sensors 552. In one embodiment, the user intent may merely be identified at a particular moment in time, for example, and the user intent may change over time based on the user context and updated patterns. In one embodiment, the real-time contextual information can be collected by sensors 552 and used to update the user patterns 554, which in turn can update the user intent 558. In this embodiment, the updated user patterns 554 can be used by the user intent determination component 406 to update the user intent 558, for example, by comparing them with real-time user context 556.

For example, if the user begins new commuting patterns (e.g., based on a new route opening, switching from car to train, new schedule at work, etc.), changes jobs, moves to a new home, or even when the activities change, the user routine updating component 532 can identify the updated patterns, for example, based on the contextual information provided by the sensors. As an illustrative example, the user (e.g., or the user's children) may play soccer in the spring and summer, and switch to football in the late summer and fall. In this example, the switch in travel patterns, timing, locations, etc. can be used to develop the updated user patterns to be used to provide appropriate suggestions in real-time. That is, adjustments can continually be made based upon a user's evolving patterns and/or behavior.

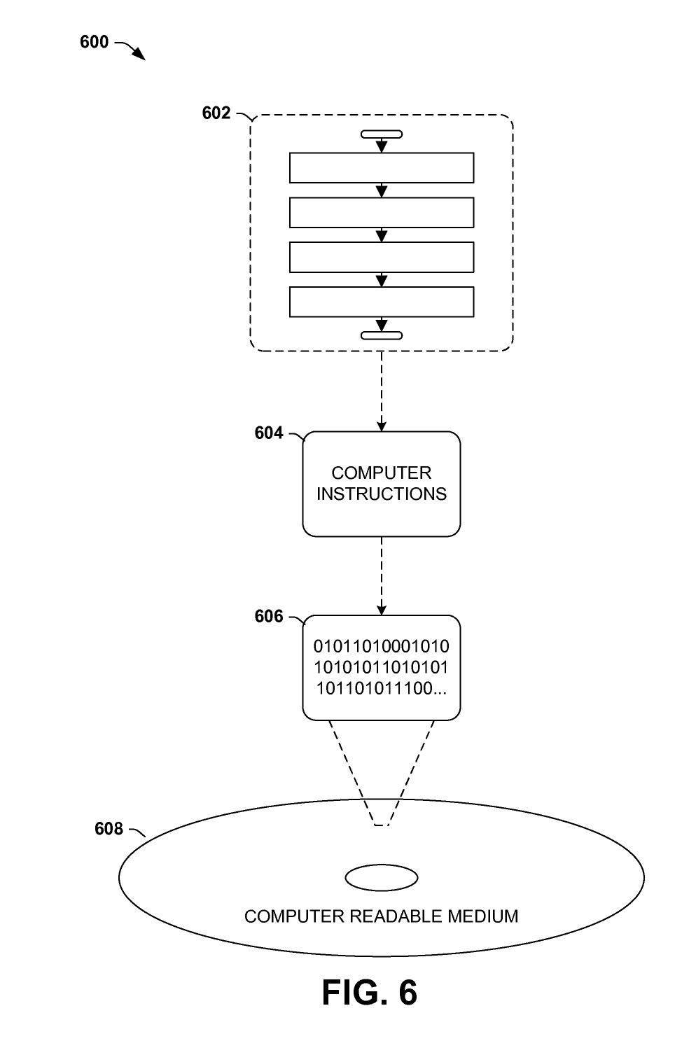

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 608 (e.g., a CD-R, DVD-R, or a platter of a hard disk drive), on which is encoded computer-readable data 606. This computer-readable data 606 in turn comprises a set of computer instructions 604 configured to operate according to one or more of the principles set forth herein. In one such embodiment 602, the processor-executable instructions 604 may be configured to perform a method, such as the exemplary method 100 of FIG. 1, for example. In another such embodiment, the processor-executable instructions 604 may be configured to implement a system, such as the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

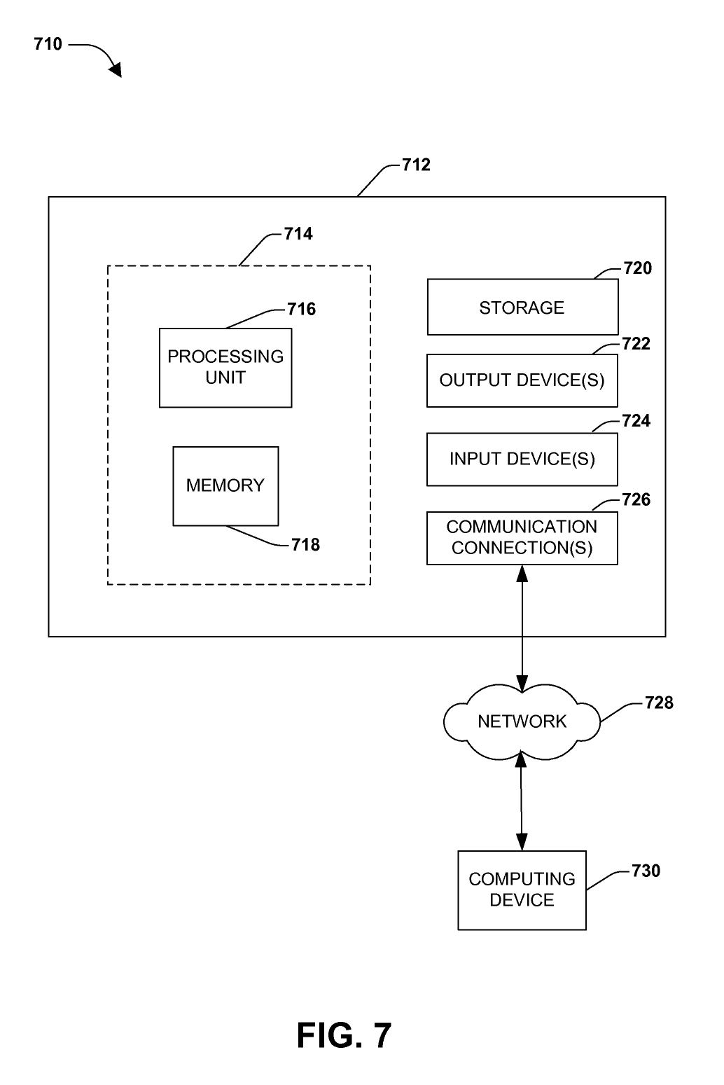

FIG. 7 and the following discussion provide a brief, general description of a suitable computing environment to implement embodiments of one or more of the provisions set forth herein. The operating environment of

FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description.

Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer based method for providing prioritized suggestions to a user of a mobile device in real-time based on an intent of the user, comprising:
identifying a routine of the user comprising identifying a plurality of historical user patterns;
identifying a real-time context for the user utilizing real-time contextual data from one or more sensors;
determining the intent of the user comprising comparing the routine with the real-time context using a computer-based processor; and
prioritizing suggestions for the user based on the intent.

2. The method of claim 1, identifying historical user patterns comprising identifying one or more of:
a user travel pattern;
a user data consumption pattern;
a user communications pattern;
a user activities pattern; and
a user profile pattern.

3. The method of claim 1, identifying the routine comprising combining at least some of the plurality of historical user patterns to identify an historical user intention.

4. The method of claim 1, identifying historical user patterns comprising utilizing data from a plurality of sensors over a desired period of time.

5. The method of claim 1, identifying a real-time context for the user utilizing real-time contextual data, comprising receiving data indicating one or more of:
a location of the user;
a current time for the location of the user;
an activity for the user;
one or more environmental conditions for the location of the user;
a proximity of the user to a desired location; and
a condition of the user.

6. The method of claim 1, identifying a real-time context for the user comprising combining the real-time contextual data to identify a potential user intention.

7. The method of claim 1, comparing the routine with the real-time context comprising comparing one or more potential user intentions with one or more historical user intentions to identify a probable user intent.

8. The method of claim 1, determining the intent of the user comprising combining one or more historical user patterns with real-time contextual data to identify a user intent.

9. The method of claim 1, prioritizing suggestions for the user based on the intent comprising:
determining a probability for the intent, where the probability comprises a likelihood of matching a preferred intent for the user; and
prioritizing the suggestions according to the probability of an associated intent.

10. The method of claim 1, comprising identifying suggestions associated with the intent using the user routine and the real-time context.

11. The method of claim 1, prioritizing suggestions comprising prioritizing one or more of:
suggested user tasks;
suggested user activities;
suggested data for the user to view; and
suggested data with which the user can interact.

12. The method of claim 10, identifying suggestions comprising identifying one or more of:
a task previously performed by the user;
an activity previously performed by the user;
a type of data previously viewed by the user;
a type of data previously interacted with by the user; and
a suggestion identified as an area of interest by the user.

13. The method of claim 1, comprising updating the routine using information from the real-time context to identify an updated user pattern.

14. A system for providing prioritized suggestions to a user of a mobile device in real-time based on an intent of the user, comprising:
a processor configured to process data for the system;
a user routine identification component configured to identify a plurality of user patterns that are associated with contextual data;
a user context identification component configured to use real-time contextual data from a plurality of sensors to identify a context for the user;
a user intent determination component configured utilize the processor to combine the user patterns with the context to identify a user intent in real-time; and
a prioritization component configured to prioritize user suggestions based on the intent.

15. The system of claim 14, comprising a presentation component configured to present the prioritized user suggestions to the user on the mobile device.

16. The system of claim 15, the presentation component comprising one or more of:
a user task presentation component configured to present prioritized tasks to the user, based on the intent;
a user data presentation component configured to present prioritized data for the user to use, based on the intent; and
a selection component configured to allow the user to select a suggestion for further use by the user.

17. The system of claim 14, comprising a contextual data capture component configured to receive contextual data from the plurality of sensors, comprising one or more of:
a global positioning service (GPS) sensor;
a location sensing component;
an accelerometer;
a clock;
an online user agent component;
an email component;
a telephonic component;
a user profile database component;
a mapping component;
one or more environmental sensing components; and
a user-based personal sensing component.

18. The system of claim 14, comprising a user scenario generation component configured to generate daily routine scenarios for the user used by the user routine identification component, comprising one or more of:
a morning scenario comprising a time from when the user rises to when the user leaves home;
a commute scenario comprising a time when the user is traveling;
a daytime scenario comprising a time during which the user engages in a work or school routine;
a lunchtime scenario comprising a time during which the user engages in lunchtime activities;
an evening scenario comprising a time from when the user arrives home until the user goes to sleep; and
a weekend scenario comprising a time when the user is not engaged in work or school for one or more days.

19. The system of claim 14 comprising a user routine updating component configured to update one or more patterns for the user using contextual information.

20. A computer based method for providing prioritized suggestions to a user of a mobile device in real-time based on an intent of the user, comprising:
identifying a routine of the user comprising identifying a plurality of historical user patterns utilizing data from a plurality of sensors over a desired period of time, comprising identifying one or more of:
a user travel pattern;
a user data consumption pattern;
a user communications pattern;
a user activities pattern; and
a user profile pattern;
identifying a real-time context for the user utilizing real-time contextual data from a plurality of sensors, comprising receiving data indicating one or more of:
a location of the user;
a current time for the location of the user;
an activity for the user;
one or more environmental conditions for the location of the user;
a proximity of the user to a desired location; and
a condition of the user;
determining the intent of the user comp comprising combining one or more historical user patterns with real-time contextual data to identify a user intent using a computer-based processor;
identifying suggestions associated with the intent using the user routine and the real-time context;
prioritizing suggestions for the user based on the intent comprising:
determining a probability for the intent, where the probability comprises a likelihood of matching a preferred intent for the user; and
prioritizing the suggestions according to the probability of an associated intent; and
updating the routine using information from the real-time context to identify an updated user pattern.
